(19) United States
(12) Patent Application Publication
(10) Pub. No.: US 2025/0037602 A1
(43) Pub. Date: Jan. 30, 2025

(54) PROVIDING A VIRTUAL CHASING CAR VIA ONE OR MORE DISPLAY UNITS

(71) Applicant: TOYOTA RESEARCH INSTITUTE, INC., Los Altos, CA (US)

(72) Inventors: Hiroshi YASUDA, San Carlos, CA (US); Jean Marcel DOS REIS COSTA, San Jose, CA (US); Tiffany L. CHEN, Mountain View, CA (US)

(73) Assignees: TOYOTA RESEARCH INSTITUTE, INC., Los Altos, CA (US); TOYOTA JIDOSHA KABUSHIKI KAISHA, Aichi-Ken (JP)

(21) Appl. No.: 18/359,826

(22) Filed: Jul. 26, 2023

(51) Int. Cl. G09B 9/042; G06F 3/14

(52) U.S. Cl. CPC G09B 9/042; G06F 3/1423

(57) ABSTRACT

A method for training a driver to navigate a path includes displaying a virtual vehicle on one or more display units integrated with a vehicle, the virtual vehicle being displayed as following the vehicle. The method also includes monitoring a location of the vehicle and a speed of the vehicle along the path. The method further includes adjusting one or both of an angle of the virtual vehicle in relation to the vehicle or a distance between the virtual vehicle and the vehicle based on monitoring the location and the speed, such that the driver adjusts one or both of a lateral position of the vehicle on the path or the speed of the vehicle in accordance with one or both of the adjusted angle or the adjusted distance.

### BACKGROUND

### Field

Certain aspects of the present disclosure generally relate to driver training, and more specifically to systems and methods for providing a virtual chase car via one or more display units.

### Background

Driver training is a process of teaching individuals skills and knowledge that may be necessary to operate a motor vehicle safely and effectively. The goal of driving training is to develop the necessary skills and abilities to navigate different road conditions and traffic situations confidently, thereby reducing the risk of accidents and injuries.

Conventional driver training programs involve a combination of theoretical and practical lessons, covering topics such as traffic laws, road signs, vehicle control, maneuvering, and defensive driving techniques. Depending on the type of driving training, the focus may vary. For example, driver education programs aim to provide basic driving knowledge to new drivers, while advanced driving courses may focus on developing specialized driving skills, such as race track driving or off-road driving.

In some cases, certified instructors may conduct training sessions either in a classroom setting or on the road. For example, some conventional driver training programs may involve a human instructor providing verbal instructions to a driver while riding in a passenger seat. Additionally, or alternatively, a leading vehicle may demonstrate the appropriate line along a road or track, providing guidance on control actions and where to look to associate actions with the location. Training aids, such as simulators or virtual reality systems, may also be used to supplement traditional training methods in some cases. These approaches have limitations, including potential issues with visibility or distractions, and may benefit from improvements to provide more effective and accessible training methods.

### SUMMARY

In one aspect of the present disclosure, a method for training a driver to navigate a path includes displaying a virtual vehicle on one or more display units integrated with a vehicle, the virtual vehicle being displayed as following the vehicle. The method still further includes monitoring a location of the vehicle and a speed of the vehicle along the path. The method also includes adjusting one or both of an angle of the virtual vehicle in relation to the vehicle or a distance between the virtual vehicle and the vehicle based on monitoring the location and the speed, such that the driver adjusts one or both of a lateral position of the vehicle on the path or the speed of the vehicle in accordance with one or both of the adjusted angle or the adjusted distance.

Another aspect of the present disclosure is directed to an apparatus including means for displaying a virtual vehicle on one or more display units integrated with a vehicle, the virtual vehicle being displayed as following the vehicle. The apparatus further includes means for monitoring a location of the vehicle and a speed of the vehicle along the path. The apparatus further includes means for adjusting one or both of an angle of the virtual vehicle in relation to the vehicle or a distance between the virtual vehicle and the vehicle based on monitoring the location and the speed, such that the driver adjusts one or both of a lateral position of the vehicle on the path or the speed of the vehicle in accordance with one or both of the adjusted angle or the adjusted distance.

In another aspect of the present disclosure, a non-transitory computer-readable medium with non-transitory program code recorded thereon is disclosed. The program code is executed by a processor and includes program code to display a virtual vehicle on one or more display units integrated with a vehicle, the virtual vehicle being displayed as following the vehicle. The program code still further includes program code to monitor a location of the vehicle and a speed of the vehicle along the path. The program code also includes program code to adjust one or both of an angle of the virtual vehicle in relation to the vehicle or a distance between the virtual vehicle and the vehicle based on monitoring the location and the speed, such that the driver adjusts one or both of a lateral position of the vehicle on the path or the speed of the vehicle in accordance with one or both of the adjusted angle or the adjusted distance.

Another aspect of the present disclosure is directed to an apparatus having a processor, and a memory coupled with the processor and storing instructions operable, when executed by the processor, to cause the apparatus to display a virtual vehicle on one or more display units integrated with a vehicle, the virtual vehicle being displayed as following the vehicle. Execution of the instructions further cause the apparatus to monitor a location of the vehicle and a speed of the vehicle along the path. Execution of the instructions also cause the apparatus to adjust one or both of an angle of the virtual vehicle in relation to the vehicle or a distance between the virtual vehicle and the vehicle based on monitoring the location and the speed, such that the driver adjusts one or both of a lateral position of the vehicle on the path or the speed of the vehicle in accordance with one or both of the adjusted angle or the adjusted distance.

Aspects generally include a method, apparatus, system, computer program product, non-transitory computer-readable medium, user equipment, base station, wireless communication device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1A is a diagram illustrating an example of a vehicle in an environment, in accordance with various aspects of the present disclosure.

FIG. 1B is a diagram illustrating an example the vehicle, in accordance with various aspects of the present disclosure.

FIG. 2 is a block diagram illustrating a software architecture that may modularize artificial intelligence (AI) functions for planning and control of an autonomous agent, in accordance with various aspects of the present disclosure.

FIG. 3 is a diagram illustrating an example of a hardware implementation for a vehicle control system, in accordance with various aspects of the present disclosure.

FIG. 4A is a diagram illustrating an example of a track superimposed with an example of a driving line of a vehicle, in accordance with various aspects of the present disclosure.

FIG. 4B is a diagram illustrating an example of the track superimposed with an example of a best line, in accordance with various aspects of the present disclosure.

FIG. 5 is diagram illustrating an example of an interior of a vehicle, in accordance with various aspects of the present disclosure.

FIG. 6 is a diagram illustrating an example of a rear-view mirror showing a virtual car, in accordance with various aspects of the present disclosure.

FIG. 7 is a diagram illustrating an example of controlling a speed of a vehicle via a virtual vehicle, in accordance with various aspects of the present disclosure.

FIG. 8A is a diagram illustrating an example of controlling a speed of a vehicle via a virtual vehicle, in accordance with various aspects of the present disclosure.

FIG. 8B is a diagram illustrating an example of controlling a speed of a vehicle via a virtual vehicle, in accordance with various aspects of the present disclosure.

FIG. 9 illustrates a flow diagram for a process for training a driver via a virtual car, in accordance with various aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts.

In some cases, certified instructors may conduct training sessions either in a classroom setting or on the road. For example, some conventional driver training programs may involve a human instructor providing verbal instructions to a driver while riding in a passenger seat. Additionally, or alternatively, a leading vehicle may demonstrate the appropriate line along a road or track, providing guidance on control actions and where to look to associate actions with the location. Training aids, such as simulators or virtual reality systems, may also be used to supplement traditional training methods in some cases. These approaches have limitations, including potential issues with visibility or distractions, and may benefit from improvements to provide more effective and accessible training methods.

Various aspects of the present disclosure are directed to providing a training aid that utilizes a simulated vehicle displayed within a display unit of a driver-operated vehicle to facilitate driver training. The display unit may include, but is not limited to, a digital rear-view mirror, one or more digital side mirrors, and/or one or more display units integrated within a dashboard and/or a console of the vehicle. In some examples, the driver training may be oriented to race track training, wherein a driver is tasked with learning an appropriate path and speed along the race track. However, aspects of the present disclosure are not limited to race track training, as other types of driver training, such as highway training or city driver training, are contemplated.

In some examples, the simulated vehicle may provide real-time feedback and guidance to the driver, thereby improving an effectiveness of the driver training process. Furthermore, the simulated vehicle may be more accurate than a human instructor, further improving the effectiveness of the driver training process. Additionally, or alternatively, the use of the simulated vehicle may reduce the need for a human instructor, thus, resulting in a more accessible and cost-effective driver training process.

As discussed, various aspects of the present disclosure may be used to train a driver of a vehicle. However, aspects of the present disclosure are not limited to vehicles, such as cars. Aspects of the present disclosure also contemplate other types of vehicles, such as boats or airplanes. In some examples, the vehicle, such as a race car or sports car, may be operated in a manual driving or a shared-control mode. Manual driving refers to a conventional driving mode, in which the driver manually controls the various functions of the vehicle, such as acceleration, braking, and steering. In contrast, in the shared-control mode the driver and the vehicle's automated systems may share control of the vehicle. In the shared-control mode, one or more systems associated with the vehicle may take over some functions. For example, the one or more systems may take control over accelerating and braking, while the driver retains control of steering.

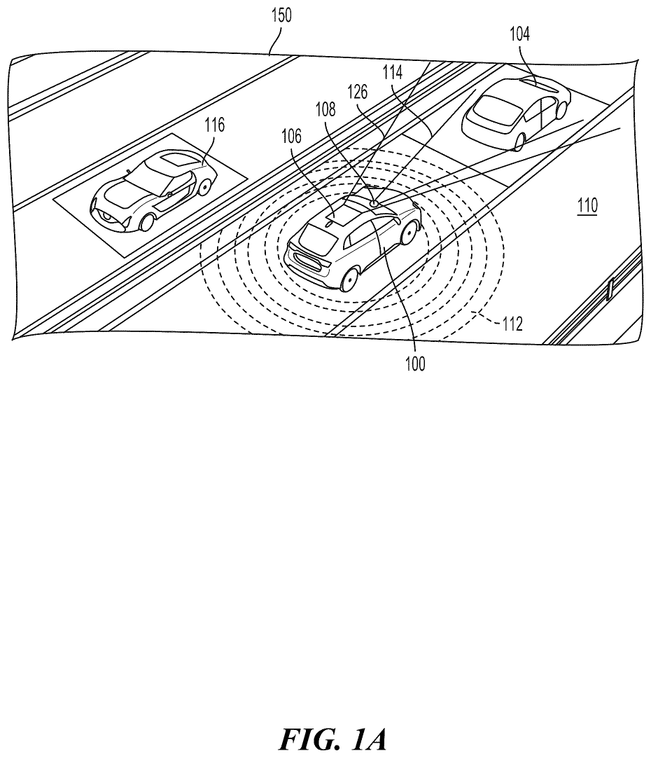

FIG. 1A is a diagram illustrating an example of a vehicle 100 in an environment 150, in accordance with various aspects of the present disclosure. In the example of FIG. 1A, the vehicle 100 may be an autonomous vehicle, a semi-autonomous vehicle, or a non-autonomous vehicle. As shown in FIG. 1A, the vehicle 100 may be traveling on a road 110. A first vehicle 104 may be ahead of the vehicle 100 and a second vehicle 116 may be adjacent to the ego vehicle 100. In this example, the vehicle 100 may include a 2D camera 108, such as a 2D red-green-blue (RGB) camera, and a LIDAR sensor 106. Other sensors, such as RADAR and/or ultrasound, are also contemplated. Additionally, or alternatively, although not shown in FIG. 1A, the vehicle 100 may include one or more additional sensors, such as a camera, a RADAR sensor, and/or a LIDAR sensor, integrated with the vehicle in one or more locations, such as within one or more storage locations (e.g., a trunk). Additionally, or alternatively, although not shown in FIG. 1A, the vehicle 100 may include one or more force measuring sensors.

In one configuration, the 2D camera 108 captures a 2D image that includes objects in the 2D camera's 108 field of view 114. The LIDAR sensor 106 may generate one or more output streams. The first output stream may include a 3D cloud point of objects in a first field of view, such as a 360° field of view 112 (e.g., bird's eye view). The second output stream 124 may include a 3D cloud point of objects in a second field of view, such as a forward facing field of view 126.

The 2D image captured by the 2D camera includes a 2D image of the first vehicle 104, as the first vehicle 104 is in the 2D camera's 108 field of view 114. As is known to those of skill in the art, a LIDAR sensor 106 uses laser light to sense the shape, size, and position of objects in the environment 150. The LIDAR sensor 106 may vertically and horizontally scan the environment 150. In the current example, the artificial neural network (e.g., autonomous driving system) of the vehicle 100 may extract height and/or depth features from the first output stream. In some examples, an autonomous driving system of the vehicle 100 may also extract height and/or depth features from the second output stream.

The information obtained from the sensors 106, 108 may be used to evaluate a driving environment. Additionally, or alternatively, information obtained from one or more sensors that monitor objects within the vehicle 100 and/or forces generated by the vehicle 100 may be used to generate notifications when an object may be damaged based on actual, or potential, movement.

FIG. 1B is a diagram illustrating an example the vehicle 100, in accordance with various aspects of the present disclosure. It should be understood that various aspects of the present disclosure may be applicable to/used in various vehicles (internal combustion engine (ICE) vehicles, fully electric vehicles (EVs), etc.) that are fully or partially autonomously controlled/operated, and as noted above, even in non-vehicular contexts, such as, e.g., shipping container packing.

The vehicle 100 may include drive force unit 165 and wheels 170. The drive force unit 165 may include an engine 180, motor generators (MGs) 182 and 184, a battery 195, an inverter 197, a brake pedal 186, a brake pedal sensor 188, a transmission 152, a memory 154, an electronic control unit (ECU) 156, a shifter 158, a speed sensor 160, and an accelerometer 162.

The engine 180 primarily drives the wheels 170. The engine 180 can be an ICE that combusts fuel, such as gasoline, ethanol, diesel, biofuel, or other types of fuels which are suitable for combustion. The torque output by the engine 180 is received by the transmission 152. MGs 182 and 184 can also output torque to the transmission 152. The engine 180 and MGs 182 and 184 may be coupled through a planetary gear (not shown in FIG. 1B). The transmission 152 delivers an applied torque to one or more of the wheels 170. The torque output by engine 180 does not directly translate into the applied torque to the one or more wheels 170.

MGs 182 and 184 can serve as motors which output torque in a drive mode, and can serve as generators to recharge the battery 195 in a regeneration mode. The electric power delivered from or to MGs 182 and 184 passes through the inverter 197 to the battery 195. The brake pedal sensor 188 can detect pressure applied to brake pedal 186, which may further affect the applied torque to wheels 170. The speed sensor 160 is connected to an output shaft of transmission 152 to detect a speed input which is converted into a vehicle speed by ECU 156. The accelerometer 162 is connected to the body of vehicle 100 to detect the actual deceleration of vehicle 100, which corresponds to a deceleration torque.

The transmission 152 may be a transmission suitable for any vehicle. For example, transmission 152 can be an electronically controlled continuously variable transmission (ECVT), which is coupled to engine 180 as well as to MGs 91 and 92. Transmission 20 can deliver torque output from a combination of engine 180 and MGs 91 and 92. The ECU 156 controls the transmission 152, utilizing data stored in memory 154 to determine the applied torque delivered to the wheels 170. For example, ECU 156 may determine that at a certain vehicle speed, engine 180 should provide a fraction of the applied torque to the wheels 170 while one or both of the MGs 182 and 184 provide most of the applied torque. The ECU 156 and transmission 152 can control an engine speed (NE) of engine 180 independently of the vehicle speed (V).

The ECU 156 may include circuitry to control the above aspects of vehicle operation. Additionally, the ECU 156 may include, for example, a microcomputer that includes a one or more processing units (e.g., microprocessors), memory storage (e.g., RAM, ROM, etc.), and I/O devices. The ECU 156 may execute instructions stored in memory to control one or more electrical systems or subsystems in the vehicle. Furthermore, the ECU 156 can include one or more electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., anti-lock braking system (ABS) or electronic stability control (ESC)), battery management systems, and so on. These various control units can be implemented using two or more separate electronic control units, or using a single electronic control unit.

The MGs 182 and 184 each may be a permanent magnet type synchronous motor including for example, a rotor with a permanent magnet embedded therein. The MGs 182 and 184 may each be driven by an inverter controlled by a control signal from ECU 156 so as to convert direct current (DC) power from the battery 195 to alternating current (AC) power, and supply the AC power to the MGs 182 and 184. In some examples, a first MG 182 may be driven by electric power generated by a second MG 184. It should be understood that in embodiments where MGs 182 and 184 are DC motors, no inverter is required. The inverter, in conjunction with a converter assembly may also accept power from one or more of the MGs 182 and 184 (e.g., during engine charging), convert this power from AC back to DC, and use this power to charge battery 195 (hence the name, motor generator). The ECU 156 may control the inverter, adjust driving current supplied to the first MG 182, and adjust the current received from the second MG 184 during regenerative coasting and braking.

The battery 195 may be implemented as one or more batteries or other power storage devices including, for example, lead-acid batteries, lithium ion, and nickel batteries, capacitive storage devices, and so on. The battery 195 may also be charged by one or more of the MGs 182 and 184, such as, for example, by regenerative braking or by coasting during which one or more of the MGs 182 and 184 operates as generator. Alternatively (or additionally, the battery 195 can be charged by the first MG 182, for example, when vehicle 100 is in idle (not moving/not in drive). Further still, the battery 195 may be charged by a battery charger (not shown) that receives energy from engine 180. The battery charger may be switched or otherwise controlled to engage/disengage it with battery 195. For example, an alternator or generator may be coupled directly or indirectly to a drive shaft of engine 180 to generate an electrical current as a result of the operation of engine 180. Still other embodiments contemplate the use of one or more additional motor generators to power the rear wheels of the vehicle 100 (e.g., in vehicles equipped with 4-Wheel Drive), or using two rear motor generators, each powering a rear wheel.

The battery 195 may also power other electrical or electronic systems in the vehicle 100. In some examples, the battery 195 can include, for example, one or more batteries, capacitive storage units, or other storage reservoirs suitable for storing electrical energy that can be used to power one or both of the MGs 182 and 184. When the battery 195 is implemented using one or more batteries, the batteries can include, for example, nickel metal hydride batteries, lithium ion batteries, lead acid batteries, nickel cadmium batteries, lithium ion polymer batteries, and other types of batteries.

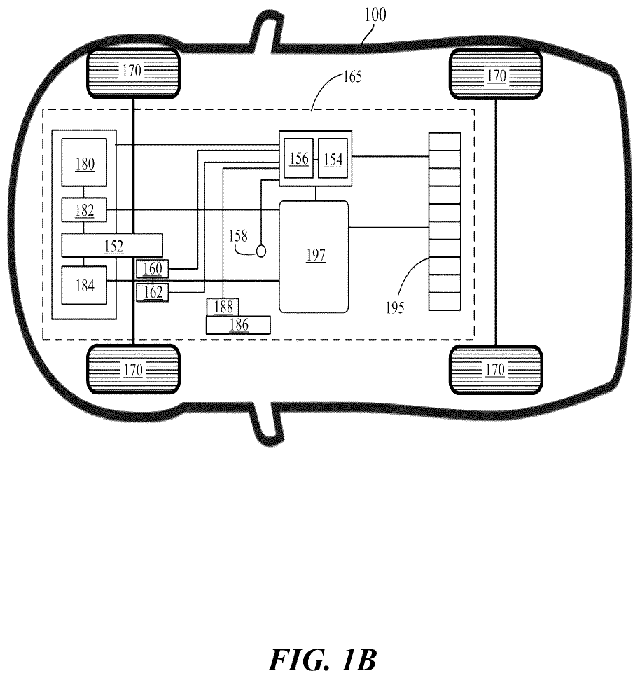

FIG. 2 is a block diagram illustrating a software architecture 200 that may modularize artificial intelligence (AI) functions for planning and/or controlling one or more actions of the vehicle 100, according to aspects of the present disclosure. Using the architecture, a controller application 202 may be designed such that it may cause various processing blocks of a system-on-chip (SOC) 220 (for example a central processing unit (CPU) 222, a digital signal processor (DSP) 224, a graphics processing unit (GPU) 226 and/or an network processing unit (NPU) 228) to perform supporting computations during run-time operation of the controller application 202.

The controller application 202 may be configured to call functions defined in a user space 204 that may, for example, provide for taillight recognition of ado vehicles. The controller application 202 may make a request to compile program code associated with a library defined in a taillight prediction application programming interface (API) 206 to perform taillight recognition of an ado vehicle. This request may ultimately rely on the output of a convolutional neural network configured to focus on portions of the sequence of images critical to vehicle taillight recognition.

A run-time engine 208, which may be compiled code of a runtime framework, may be further accessible to the controller application 202. The controller application 202 may cause the run-time engine 208, for example, to take actions for controlling the autonomous agent. When an ado vehicle is detected within a predetermined distance of the autonomous agent, the run-time engine 208 may in turn send a signal to an operating system 210, such as a Linux Kernel 212, running on the SOC 220. The operating system 210, in turn, may cause a computation to be performed on the CPU 222, the DSP 224, the GPU 226, the NPU 228, or some combination thereof. The CPU 222 may be accessed directly by the operating system 210, and other processing blocks may be accessed through a driver, such as drivers 214-218 for the DSP 224, for the GPU 226, or for the NPU 228. In the illustrated example, the deep neural network may be configured to run on a combination of processing blocks, such as the CPU 222 and the GPU 226, or may be run on the NPU 228, if present.

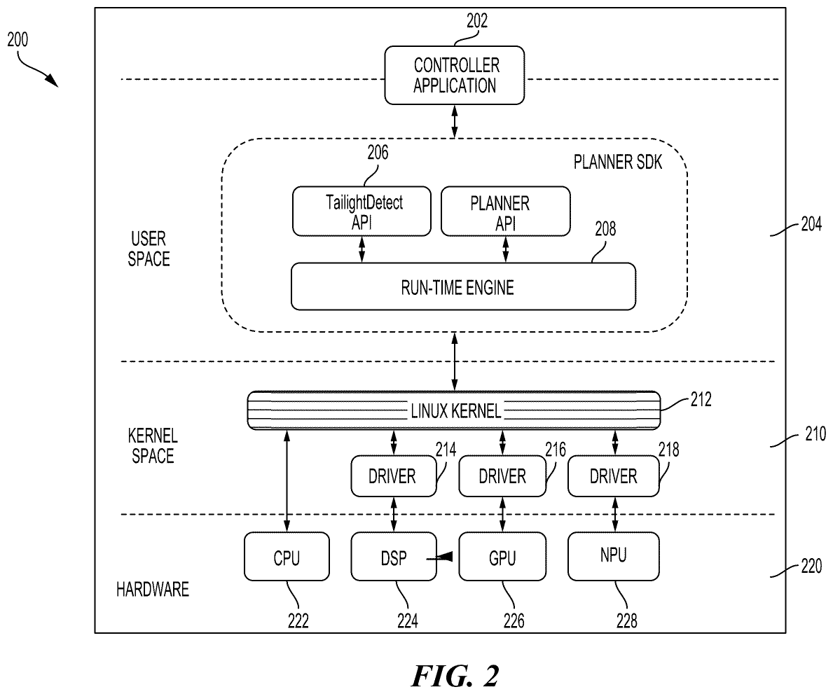

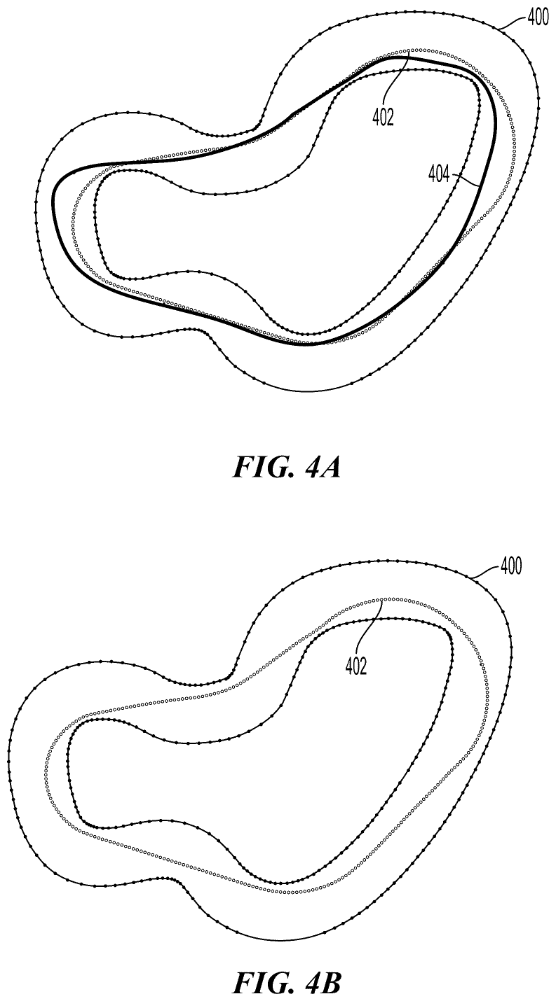

FIG. 3 is a diagram illustrating an example of a hardware implementation for a vehicle control system 300, according to aspects of the present disclosure. The vehicle control system 300 may be a component of a vehicle, a robotic device, or other device. For example, as shown in FIG. 3, the vehicle control system 300 is a component of a vehicle 100. Aspects of the present disclosure are not limited to the vehicle control system 300 being a component of the vehicle 100, as other devices, such as a bus, boat, drone, or robot, are also contemplated for using the vehicle control system 300. In the example of FIG. 3, the vehicle system may include a training system 390. In some examples, training system 390 is configured to perform operations, including operations of the process 500 described with reference to FIG. 5.

The vehicle control system 300 may be implemented with a bus architecture, represented generally by a bus 330. The bus 330 may include any number of interconnecting buses and bridges depending on the specific application of the vehicle control system 300 and the overall design constraints. The bus 330 links together various circuits including one or more processors and/or hardware modules, represented by a processor 320, a communication module 322, a location module 318, a sensor module 302, a locomotion module 323, a planning module 324, and a computer-readable medium 313. The bus 330 may also link various other circuits such as timing sources, peripherals, voltage regulators, and power management circuits, which are well known in the art, and therefore, will not be described any further.

The vehicle control system 300 includes a transceiver 314 coupled to the processor 320, the sensor module 302, a comfort module 308, the communication module 322, the location module 318, the locomotion module 323, the planning module 324, and the computer-readable medium 313. The transceiver 314 is coupled to an antenna 333. The transceiver 314 communicates with various other devices over a transmission medium. For example, the transceiver 314 may receive commands via transmissions from a user or a remote device. As another example, the transceiver 314 may transmit driving statistics and information from the comfort module 308 to a server (not shown).

In one or more arrangements, one or more of the modules 302, 313, 314, 318, 320, 322, 323, 324, 390, can include artificial or computational intelligence elements, such as, neural network, fuzzy logic or other machine learning algorithms. Further, in one or more arrangements, one or more of the modules 302, 313, 314, 318, 320, 322, 323, 324, 390 can be distributed among multiple modules 302, 313, 314, 318, 320, 322, 323, 324, 390 described herein. In one or more arrangements, two or more of the modules 302, 313, 314, 318, 320, 322, 323, 324, 390 of the vehicle control system 300 can be combined into a single module.

The vehicle control system 300 includes the processor 320 coupled to the computer-readable medium 313. The processor 320 performs processing, including the execution of software stored on the computer-readable medium 313 providing functionality according to the disclosure. The software, when executed by the processor 320, causes the vehicle control system 300 to perform the various functions described for a particular device, such as the vehicle 328, or any of the modules 302, 313, 314, 318, 320, 322, 323, 324, 390. The computer-readable medium 313 may also be used for storing data that is manipulated by the processor 320 when executing the software.

The sensor module 302 may be used to obtain measurements via different sensors, such as a first sensor 303A and a second sensor 303B. The first sensor 303A and/or the second sensor 303B may be a vision sensor, such as a stereoscopic camera or a red-green-blue (RGB) camera, for capturing 2D images. In some examples, one or both of the first sensor 303A or the second sensor 303B may be used to identify an intersection, a crosswalk, or another stopping location. Additionally, or alternatively, one or both of the first sensor 303A or the second sensor 303B may identify objects within a range of the vehicle 100. In some examples, one or both of the first sensor 303A or the second sensor 303B may identify a pedestrian or another object in a crosswalk. The first sensor 303A and the second sensor 303B are not limited to vision sensors as other types of sensors, such as, for example, light detection and ranging (LiDAR), a radio detection and ranging (radar), sonar, and/or lasers are also contemplated for either of the sensors 303A, 303B. The measurements of the first sensor 303A and the second sensor 303B may be processed by one or more of the processor 320, the sensor module 302, the comfort module 308, the communication module 322, the location module 318, the locomotion module 323, the planning module 324, in conjunction with the computer-readable medium 313 to implement the functionality described herein. In one configuration, the data captured by the first sensor 303A and the second sensor 303B may be transmitted to an external device via the transceiver 314. The first sensor 303A and the second sensor 303B may be coupled to the vehicle 328 or may be in communication with the vehicle 328.

Additionally, the sensor module 302 may configure the processor 320 to obtain or receive information from the one or more sensors 303A and 303B. The information may be in the form of one or more two-dimensional (2D) image(s) and may be stored in the computer-readable medium 313 as sensor data. In the case of 2D, the 2D image is, for example, an image from the one or more sensors 303A and 303B that encompasses a field-of-view about the vehicle 100 of at least a portion of the surrounding environment, sometimes referred to as a scene. That is, the image is, in one approach, generally limited to a subregion of the surrounding environment. As such, the image may be of a forward-facing (e.g., the direction of travel) 30, 90, 120-degree field-of-view (FOV), a rear/side facing FOV, or some other subregion as defined by the characteristics of the one or more sensors 303A and 303B. In further aspects, the one or more sensors 303A and 303B may be an array of two or more cameras that capture multiple images of the surrounding environment and stitch the images together to form a comprehensive 330-degree view of the surrounding environment. In other examples, the one or more images may be paired stereoscopic images captured from the one or more sensors 303A and 303B having stereoscopic capabilities.

The location module 318 may be used to determine a location of the vehicle 328. For example, the location module 318 may use a global positioning system (GPS) to determine the location of the vehicle 328. The communication module 322 may be used to facilitate communications via the transceiver 314. For example, the communication module 322 may be configured to provide communication capabilities via different wireless protocols, such as Wi-Fi, long term evolution (LTE), 3G, etc. The communication module 322 may also be used to communicate with other components of the vehicle 328 that are not modules of the vehicle control system 300. Additionally, or alternatively, the communication module 322 may be used to communicate with an occupant of the vehicle 100. Such communications may be facilitated via audio feedback from an audio system of the vehicle 100, visual feedback via a visual feedback system of the vehicle, and/or haptic feedback via a haptic feedback system of the vehicle.

The locomotion module 323 may be used to facilitate locomotion of the vehicle 328. As an example, the locomotion module 323 may control movement of the wheels. As another example, the locomotion module 323 may be in communication with a power source of the vehicle 328, such as an engine or batteries. Of course, aspects of the present disclosure are not limited to providing locomotion via wheels and are contemplated for other types of components for providing locomotion, such as propellers, treads, fins, and/or jet engines.

The vehicle control system 300 also includes the planning module 324 for planning a route or controlling the locomotion of the vehicle 328, via the locomotion module 323. A route may be planned to a passenger based on compartment data provided via the comfort module 308. In one configuration, the planning module 324 overrides the user input when the user input is expected (e.g., predicted) to cause a collision. The modules may be software modules running in the processor 320, resident/stored in the computer-readable medium 313, one or more hardware modules coupled to the processor 320, or some combination thereof.

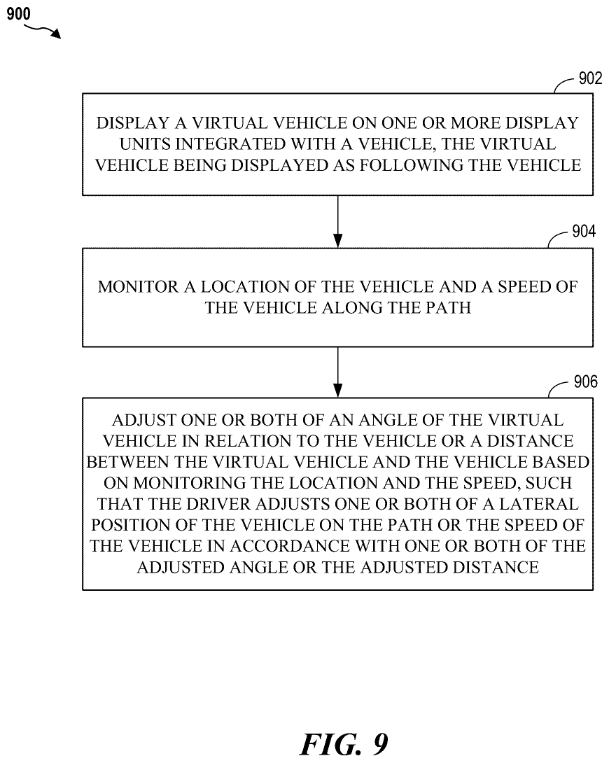

The training system 390 may be in communication with the sensor module 302, the transceiver 314, the processor 320, the communication module 322, the location module 318, the locomotion module 323, the planning module 324, and the computer-readable medium 313. In some examples, the training system 390 may be implemented as a machine learning model. Working in conjunction with one or more of the sensors 303A, 303B, the sensor module 302, and/or one or more other modules 313, 314, 318, 320, 322, 323, 324, the training system 390 may perform one or more elements of the process 900 described with reference to FIG. 9.

As discussed, in some conventional driver training programs, a certified instructor may conduct training sessions either in a classroom setting or on the road. For example, some conventional driver training programs may involve a human instructor providing verbal instructions to a driver while riding in a passenger seat. Additionally, or alternatively, a leading vehicle may demonstrate the appropriate line along a road or track, providing guidance on control actions and where to look to associate actions with the location.

In some examples, training aids, such as simulators or virtual reality systems, may also be used to supplement traditional training methods in some cases. Some conventional driver training systems may use a virtual car displayed via a heads-up display (HUD). The HUD may be integrated with the vehicle's windshield, the driver's helmet, and/or a display unit of the vehicle. Such systems are not robust against visibility issues caused by sun glare or bright lights. Furthermore, such systems do not provide a comprehensive field of vision because the HUD may be limited to a certain location of the vehicle, such as directly in front of the driver, and may not display the virtual car via the entire front windshield. Therefore, these conventional solutions have various limitations, including potential issues with visibility or distractions, and may benefit from improvements to provide more effective and accessible training methods. Various aspects of the present disclosure are directed to providing a training aid that utilizes a simulated vehicle displayed within a display unit of a driver-operated vehicle to facilitate driver training. The simulated vehicle may be a training aid. In some examples, the driver may learn how to control their vehicle's speed and position in accordance with real-time feedback and guidance provided by the simulated vehicle. The display unit may include, but is not limited to, a digital rear-view mirror, one or more digital side mirrors, and/or one or more display units integrated within a dashboard and/or a console of the vehicle. In some examples, the driver training may be oriented to race track training, wherein a driver is tasked with learning an appropriate path and speed along the race track. However, aspects of the present disclosure are not limited to race track training, as other types of driver training, such as highway training or city driver training, are contemplated.

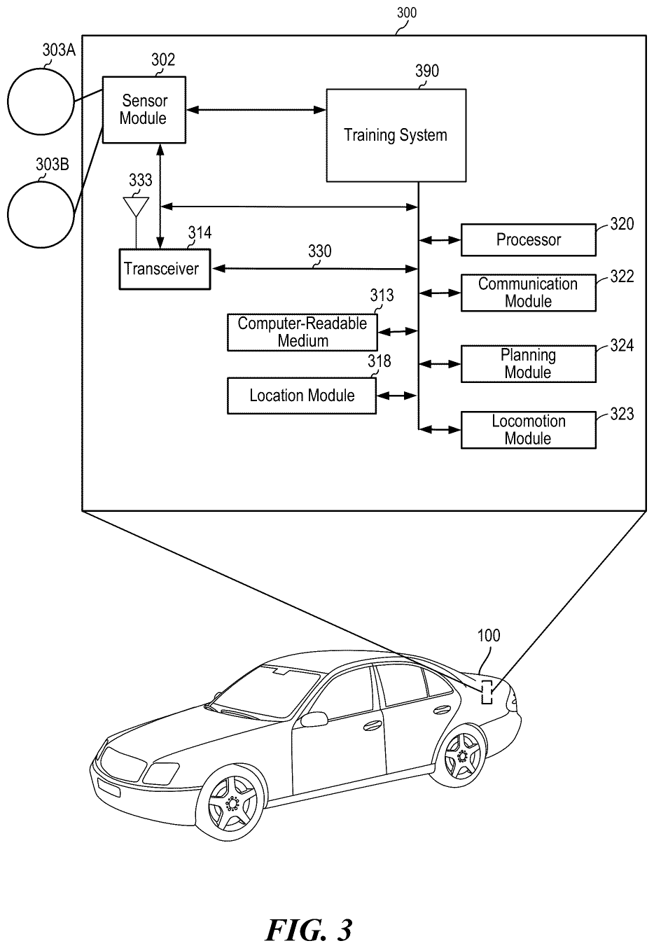

FIG. 4A is a diagram illustrating an example of a track 400 superimposed with an example of a driving line 404 of a vehicle, in accordance with various aspects of the present disclosure. In the example of FIG. 4A, the vehicle may be an example of the vehicle 100 described with reference to FIGS. 1A, 1B, and 3. In most cases, a driver aims to control the vehicle along the track 400 to achieve a fastest lap time (e.g., time through the track 400). The track 400 may be an example of a circuit, a path, or a race track. The driving line 404 represents an example of a path taken by the vehicle through the track 400. The driving line 404 is merely one example, other driving lines are possible. It may be desirable to train a driver to optimize the driving line 404, such that the vehicle minimizes a lap time. In some examples, a simulated vehicle may be used to train the driver to drive the best line. The best line may also be referred to as an ideal route (hereinafter used interchangeably).

FIG. 4B is a diagram illustrating an example of the track 400 superimposed with an example of a best line 402, in accordance with various aspects of the present disclosure. In most cases, a goal of a race car driver is to use the best line 402 to navigate a vehicle, such as the vehicle 100 described with reference to FIGS. 1A, 1B, and 3, through the race track 402 in accordance with a fastest possible path. The best line 402 may be an example of an ideal racing line that is associated with the fastest possible path through the track 400. The best line may also be referred to as an ideal line or an ideal path. In the example of FIG. 4B, the best line 402 differs from the driving line 404 shown in FIG. 4A. Thus, the driver associated with the driving line 404 may be in need of training to achieve the best line 402 on the track 400. It should be noted that the best line 402 is not a physical line on the track 400, rather, it is a theoretical line that may be used to achieve a fastest lap time.

Various guidelines may be defined for the best line 402. For ease of explanation, the best line 402 may balance the following guidelines, while finding the fasted possible path through the race track 400. The guidelines include, but are not limited to using a full width of the track 400, reducing an amount of braking, accelerating through a curve, and driving in a straight line as much as possible.

Using a full width of the track may allow the vehicle to achieve the widest possible turning radius around a curve. This may achieve the fastest path through the track 400 because the wider the turn, the faster the vehicle can go through it. Reducing the amount of braking may be quantified based on an amount of deceleration and/or an amount of time associated with applying the brakes. It may be desirable to apply the brakes prior to beginning a turn. Additionally, the vehicle may achieve the fastest path through the track 400 by exiting a curve at full throttle. Finally, maximizing an amount of time driving in the straight line may maximize an total amount of time spent at a top speed.

Beyond these guidelines, finding the best line 402 may also depend on various factors, such as load balancing of the vehicle, a nature of the track 400, and the driver's reaction time and state of mind. In some aspects of the present disclosure, one or more best lines 402 may be generated by a human driver and/or a machine learning model. In some examples, one or more drivers may drive the course, and the best line 402 may be a function, such as an average, of the drivers' fastest time. Additionally, or alternatively, the machine learning model may learn the best line 402 associated with a fastest time through the track 400 based on the one or more guidelines as well as other factors, such as load balancing, the nature of the track, human reaction times, vehicle types, and/or other factors. In some examples, a group of best lines may be, where each best line of the group of best lines may be associated with one or more of a respective driving condition, respective driving style, and/or respective vehicle. In such examples, during training, the driver may select a best line from the group of best lines. In some examples, the machine learning model may adapt one or more best lines to a driver's specific abilities. Additionally, or alternatively, the machine learning model may adapt one or more best lines based on a vehicle, driving conditions (e.g., weather), road conditions, and/or other factors.

Additionally, or alternatively, in some examples, the best line 402 may be determined by recording of the driver's previous laps. This data may provide insights into a driver's consistent route, potentially pointing to the driver's optimal line based on their unique driving style, their choice of vehicle, and their reaction to specific track conditions. Additionally, or alternatively, in some examples, the best line 402 may be determined by recording one or more professional drivers. In such examples, the seasoned expertise and experience of the one or more professional drivers may guide the driver training system to select the quickest path around a track. That is, the best line 402 may be based on one or more routes used by the one or more professional drivers.

Additionally, or alternatively, in some examples, the best line 402 may be determined based on a computer simulation. By incorporating factors such as the vehicle's physics, the layout and condition of the track, and prevailing environmental conditions, these computer simulation may calculate and suggest the ideal route (e.g., best line 402).

The computer simulation, driver's previous laps, and/or professional driver laps may be integrated with the machine learning model to adapt the best line 402 to a range of factors including the driver's specific abilities, the vehicle, the driving conditions like weather, road conditions, and more. This multifaceted strategy can aid in improving driver performance and refining vehicular navigation on the course, thereby fostering quicker lap times and more efficient driving habits.

Aspects of the present disclosure are not limited to finding the best line 402 for the track 400 illustrated in FIG. 4B. The track 400 is used as an example, one or more best lines may be determined for one or more tracks used to train a driver. Each of the one or more best lines may be stored in computer-readable medium (e.g., memory) associated with the vehicle, such as the computer-readable medium 313 described with reference to FIG. 3. Additionally, or alternatively, each of the one or more best lines may be stored in the respective computer-readable medium of one or more remote devices associated with a driver training system. In some such examples, the one or more best lines may be wirelessly transmitted to the vehicle prior to training a driver on a track. In some examples, the vehicle may autonomously transmit its positioning information to the driver training system, such that the driver training system automatically transmits the one or more best lines associated with a track corresponding to the vehicle's current location in response to receiving the positioning information from the vehicle.

In some examples, a driver or a trainer loads a desired best line associated with the track where the driver will be trained prior to initiating a driving training program. The best line may be selected from one or more tracks stored in the vehicle or received from remote devices via a wireless connection. Once the driver selects the desired best line, the virtual vehicle, also referred to as a simulated vehicle, may be used to guide the driver along the best line.

The virtual vehicle serves as a training aid that provides real-time feedback and guidance to the driver. The feedback and guidance enable the driver to learn how to control the vehicle's speed and position. In some examples, the virtual vehicle is displayed on one or more display units integrated with the vehicle. These display units may include a rear-view mirror, a left-side view mirror, a right-side view mirror, an in-dash display, a console display, and/or any other display unit integrated with the vehicle. Displaying the virtual vehicle in one or more display units may improve a driver's situational awareness and driving skills.

FIG. 5 is diagram illustrating an example of an interior 500 of a vehicle, in accordance with various aspects of the present disclosure. The vehicle may be an example of the vehicle 100 described with reference to FIGS. 1A, 1B, and 3. The interior 500 may also be referred to as a cabin. In the example of FIG. 5, the interior 500 includes various display units, such as a rear-view mirror 502, in-dash display unit 504, and instrument panel display unit 508. A left-side mirror 506A and right-side mirror 506B may also be integrated with the vehicle in some examples. The use of one or more of the display units 502, 504, 506A, 506B, or 508 may provide a variety of locations to display a virtual vehicle or other computer-generated images.

Each of the display units 502, 504, 506A, 506B, and 508 may display a virtual vehicle, which may be used to train the driver in various driving techniques. For instance, each of the display units 502, 504, 506A, 506B, and 508 may display a virtual vehicle that appears to be chasing the driver's vehicle, providing real-time instructions to the driver through its location on the roadway within the respective display unit 502, 504, 506A, 506B, and 508. The virtual vehicle may be simultaneously displayed on two or more of the display units 502, 504, 506A, 506B, and 508 or only a single display unit 502, 504, 506A, 506B, and 508, depending on driver preference.

In some examples, the left side mirror 506A, right side mirror 506B, and rear-view mirror 502 may function as both mirrors that reflect an image and display units that show computer-generated images. This dual functionality may enhance their situational awareness while driving, while also providing basic functionality of providing rear-views to the driver. It should be noted that while FIG. 5 shows a particular arrangement of display units within the vehicle interior, aspects of the present disclosure are not limited to the particular configuration of FIG. 5. Additional, or fewer, display units may also be integrated with various locations within the interior of the vehicle, such as a center console or other areas.

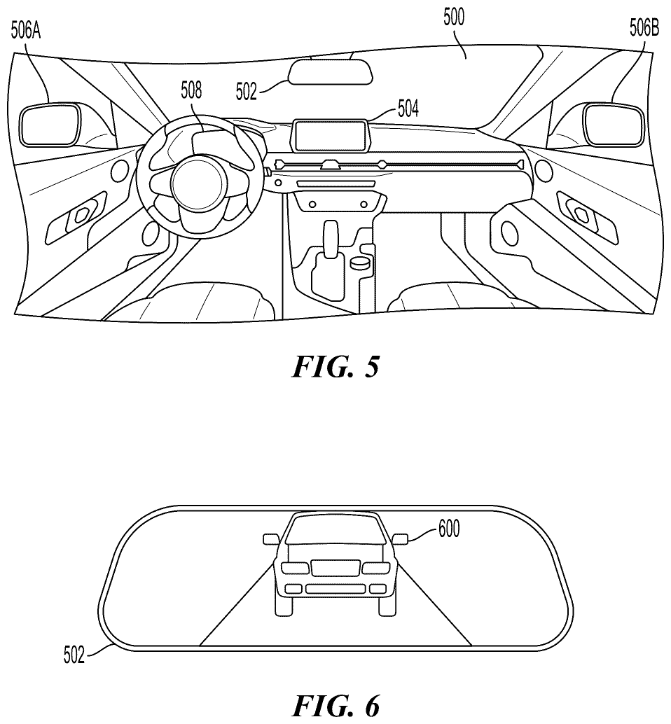

FIG. 6 is a diagram illustrating an example of a rear-view mirror 502 showing a virtual car 600, in accordance with various aspects of the present disclosure. In the example of FIG. 6, the virtual vehicle 600 may appear to be chasing a vehicle associated with the rear-view mirror 502. The vehicle may be an example of the vehicle 100 described with reference to FIGS. 1A, 1B, and 3. The vehicle may be training on a track, such as the track 400 described with reference to FIGS. 4A and 4B. As discussed, the virtual vehicle 600 is not limited to being displayed via the rear-view mirror 502, the virtual vehicle 600 may be displayed in one or more display units, such as one or more of the display units 502, 504, 506A, 506B, or 508 described with reference to FIG. 5. It should be noted that the virtual vehicle 600 does not physically exist behind the vehicle 100. Rather, the virtual vehicle 600 may be generated via one or more components integrated with the vehicle, such as the driver training module 390, the processor 320, planning module 324, computer-readable medium 313, and/or other modules.

As discussed, the driver may learn to navigate a track based on monitoring a location of the virtual vehicle 600. That is, the location of the virtual vehicle 600 on a track (e.g., roadway) within the mirror 502 may provide instructions to the driver. For example, the virtual vehicle 600 may displayed, in the mirror 502, as approaching the vehicle if the vehicle's speed is less than a speed threshold corresponding to a particular section of the track. That is, the virtual vehicle 600 may be shown to be at a distance to is equal to or less than a distance threshold from the vehicle when the vehicle's speed is less than the speed threshold corresponding to the particular section of the track. Additionally, or alternatively, a color of the virtual vehicle 600 may change when the vehicle's speed is less than a speed threshold corresponding to a particular section of the track. For example, the color of the virtual vehicle 600 may be red when the vehicle's speed is less than the speed threshold and the color may be green when the vehicle's speed is equal to or greater than the speed threshold.

In some examples, the virtual vehicle 600 displayed in the mirror 502, and/or other display units may also indicate the necessary steering corrections to stay on the best line. That is, the virtual vehicle 600 may also correct a lateral movement (e.g., left and right movement) of the vehicle. For example, the location of the virtual vehicle 600 within the mirror 502 may change based on the lateral position of the vehicle. For instance, if the driver is veering off course, the virtual car's position in the mirror 502 may shift to indicate the necessary steering corrections. The driver may correct the vehicle such that the virtual vehicle 600 is within a center of the mirror 502. Additionally, or alternatively, the virtual vehicle 600 may disappear from the mirror 502 when the driver is on the best line or at a correct speed.

In addition to, or alternate from, changes in an appearance of the virtual vehicle 600, such as changes to the color to indicate a correct speed and/or a correct line, other characteristics of the virtual vehicle 600 may change. For example, the virtual vehicle 600 may flash in the mirror 502. Additionally, or alternatively, an intensity of the overlay displayed in the mirror 502 may also be adjusted based on the difference in the appropriate speed. A brightness of the virtual vehicle 600 may correspond to the intensity. Other display characteristics may also correspond to the intensity. The adjustment to the color and/or other characteristics may make it easier for the driver to identify their driving performance. Furthermore, the display of the virtual vehicle in the mirror 502 may be customized based on the driver's preferences or driving conditions. For example, a size or a location of the virtual vehicle 600 in the mirror 502 may be adjusted to better suit the driver's visibility or driving style.

Overall, the use of a virtual vehicle 600 displayed within a mirror 502 or other display unit offers several advantages over traditional heads-up display (HUD) systems. The virtual vehicle can provide real-time feedback and guidance to the driver, enhancing situational awareness and improving driving skills. The virtual vehicle 600 is also more robust against visibility issues caused by sun glare or bright lights and provides a more comprehensive field of vision that can cover multiple mirrors.

As discussed, in some examples, a virtual vehicle may appear to approach a vehicle (e.g., training vehicle), if the vehicle's speed is less than a speed threshold at a particular location of a track. In some examples, the vehicle's location may be monitored via one or more positioning components, such as a GPS component. The location module 318 described with reference to FIG. 3 is an example of a positioning component. In such examples, positioning information obtained from the one or more positioning components may be used by the vehicle and/or a remote driver training system to determine the vehicle's current location on the track. The positioning information and/or other information, such as the vehicle's current speed or acceleration, may be used to determine whether the vehicle's speed satisfies a speed condition associated with the vehicle's location on the track. The speed condition may be satisfied when the vehicle's speed is equal to or greater than a speed threshold. The vehicle may minimize a lap time by satisfying the speed condition throughout the track.

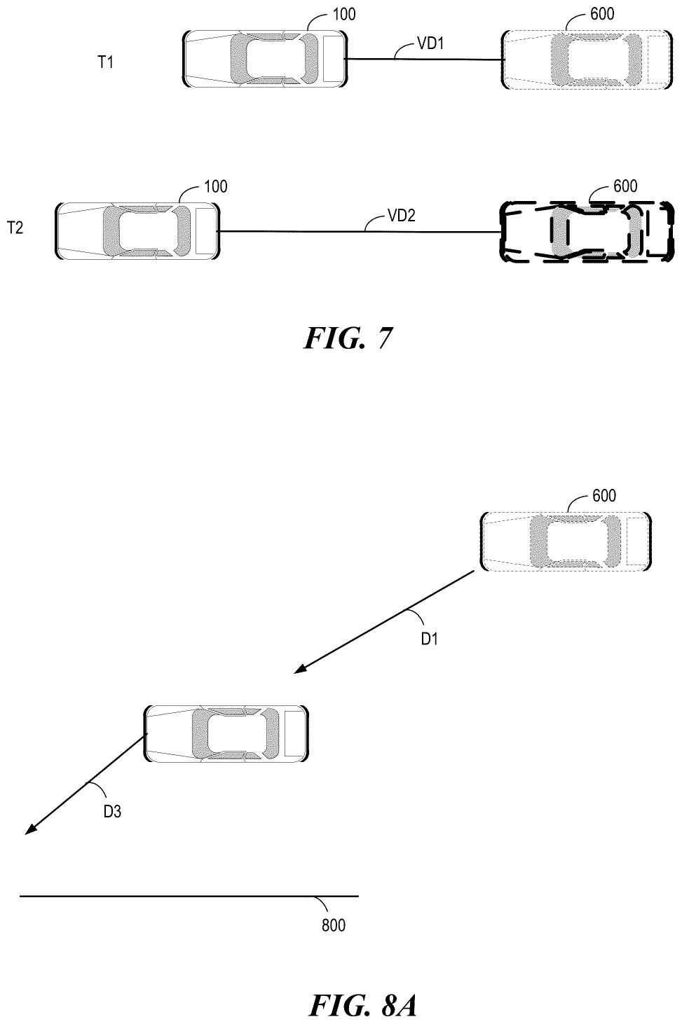

FIG. 7 is a diagram illustrating an example of controlling a speed of a vehicle 100 via a virtual vehicle 600, in accordance with various aspects of the present disclosure. As discussed, the vehicle 100 and/or a remote device, such as a remote server, may monitor the speed and location of the vehicle 100. If the vehicle's 100 speed fails to satisfy a speed condition at the vehicle's 100 current location on a track, at time t1, the virtual vehicle 600 may be displayed via a display unit, such as a display unit 502, 504, 506A, 506B, or 508 described with reference to FIG. 5, as approaching the vehicle 100.

In the example of FIG. 7, the virtual vehicle 600 may provide real-time feedback to the driver of vehicle 100. At time t1, the virtual vehicle 600 may appear to be approaching the vehicle 100, if the vehicle 100 does not satisfy the speed condition. That is, at time t1, a first virtual distance VD1 between the vehicle 100 and the virtual vehicle 600 may be reduced to be less than a distance threshold, which indicates to the driver that they need to accelerate. In addition to the distance threshold, one or more characteristics, such as the color or intensity of the virtual vehicle 600, may also change to indicate that the speed condition is not being met. For example, the virtual vehicle 600 may turn red to indicate that the speed threshold is not being met.

Upon seeing the virtual vehicle 600 approaching, the driver may accelerate the vehicle 100 at time t2. As the vehicle 100 accelerates, a second virtual distance VD2 between the vehicle 100 and the virtual vehicle 600 may appear to increase on the display unit. The second virtual distance VD2 may remain larger than the first virtual distance VD1, as long as the speed condition is satisfied. The virtual vehicle 600 may also change its color or intensity to indicate that the speed condition is being met. For instance, the virtual vehicle 600 may turn green to indicate that the vehicle 100 satisfies the speed condition. In the example of FIG. 7, at time t2, an intensity of the virtual vehicle 600 increased (shown as bolded lines) to indicate the vehicle 100 has satisfied the speed condition.

In some other examples, the vehicle 100 may fail to satisfy the speed condition if a current speed is less than a first speed threshold or if the current speed is greater than a second speed threshold. That is, the vehicle 100 may fail to satisfy the speed condition if the vehicle 100 is traveling too fast at a particular section of the track. For example, the vehicle 100 may be entering a turn too fast, which may result in a loss of control. In some such examples, the virtual vehicle 600 may increase the distance between the vehicle 100 and the virtual vehicle 600 to indicate the vehicle is exceeding the second speed threshold. Additionally, or alternatively, the virtual vehicle 600 may change one or more characteristics, such as a color or intensity, to indicate the vehicle 100 is exceeding the second speed threshold.

The use of the virtual vehicle 600 in this way provides real-time feedback to the driver and allows them to make adjustments to their driving in order to follow the best line and optimize their lap time. Aspects of the present disclosure are not limited to adjusting a virtual distance between the virtual vehicle 600 and the vehicle 100 based on the vehicle 100

Additionally, or alternatively, in some examples, the positioning information obtained from the GPS component and/or other positioning components can be used to monitor the lateral deviation of the vehicle from the best line. If the vehicle has laterally deviated from the best line, the virtual vehicle can be used to adjust the vehicle's lateral position. The driver training module, such as the driver training module 390, may utilize the positioning information and/or the vehicle's speed to display the virtual vehicle on one or more display units, thereby allowing the driver to correct their speed and/or location within the track to adhere to the best line.

Moreover, the positioning information and/or the vehicle's speed can be wirelessly transmitted to an external device, such as a remote server. This external device can then control the display of the virtual vehicle via one or more display units in order to correct the vehicle's speed and/or location within the track to adhere to the best line. This feature allows for remote monitoring and guidance of a driver's performance on the track, which can be especially useful in competitive settings.

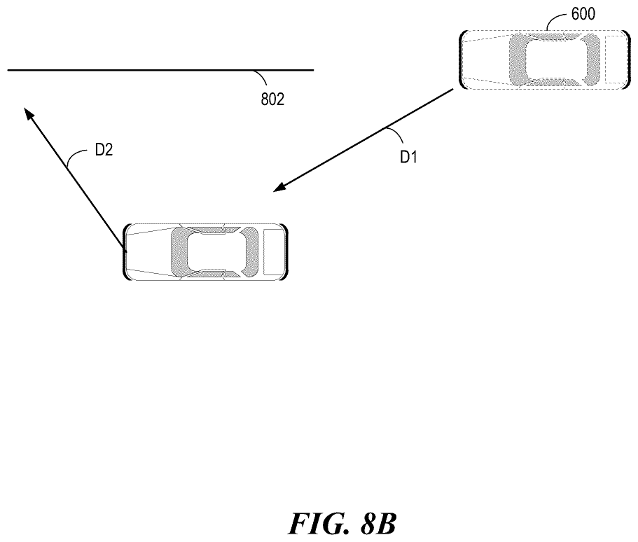

FIG. 8A is a diagram illustrating an example of controlling a speed of a vehicle 100 via a virtual vehicle 600, in accordance with various aspects of the present disclosure. As discussed, the vehicle 100 and/or a remote device, such as a remote server, may monitor a location of the vehicle 100. If the vehicle's 100 the vehicle has laterally deviated from a best line 800, the virtual vehicle 600 can be used to adjust the vehicle's 100 lateral position.

In the example of FIG. 8A, when the vehicle 100 has deviated from the best line 800, the virtual vehicle 600 may be displayed via a display unit, such as a display unit 502, 504, 506A, 506B, or 508 described with reference to FIG. 5, as approaching the vehicle 100 from an angle D1. For example, the virtual vehicle 600 may appear at a side mirror, such as the side mirror 506B, or at a corner of a rear-view mirror, such as the rear-view mirror 602. Additionally, or alternatively, one or more characteristics, such as the color or intensity of the virtual vehicle 600, may also change to indicate that the vehicle 100 has laterally deviated from the best line 100.

Upon seeing the virtual vehicle 600 in the one or more display units, the driver may adjust the lateral position of the vehicle 100 in a direction D1 toward the best line 800. A location of the virtual vehicle 600 may change within the one or more displays as the vehicle 100 nears the best line 800. In some examples, the virtual vehicle 600 disappears when the vehicle 100 is on the best line 800. Alternatively, the virtual vehicle 600 may also change its color or intensity to indicate that the vehicle 100 is on the best line 800.

FIG. 8B is a diagram illustrating an example of controlling a speed of a vehicle 100 via a virtual vehicle 600, in accordance with various aspects of the present disclosure. As discussed, the vehicle 100 and/or a remote device, such as a remote server, may monitor a location of the vehicle 100. If the vehicle's 100 the vehicle has laterally deviated from a best line 800, the virtual vehicle 600 can be used to adjust the vehicle's 100 lateral position.

In the example of FIG. 8B, when the vehicle 100 has deviated from the best line 800, the virtual vehicle 600 may be displayed via a display unit, such as a display unit 502, 504, 506A, 506B, or 508 described with reference to FIG. 5, as approaching the vehicle 100 from an angle D1. For example, the virtual vehicle 600 may appear at a side mirror, such as the side mirror 506B, or at a corner of a rear view mirror, such as the rear view mirror 602. Additionally, or alternatively, one or more characteristics, such as the color or intensity of the virtual vehicle 600, may also change to indicate that the vehicle 100 has laterally deviated from the best line 100.

Upon seeing the virtual vehicle 600 in the one or more display units, the driver may adjust the lateral position of the vehicle 100 in a direction D2 toward the best line 800. A location of the virtual vehicle 600 may change within the one or more displays as the vehicle 100 nears the best line 800. In some examples, the virtual vehicle 600 appears in a center of a display unit (e.g., directly behind the vehicle 100) when the vehicle 100 is on the best line 800. Additionally, or alternatively, the virtual vehicle 600 may also change its color or intensity to indicate that the vehicle 100 is on the best line 800.

In the examples of FIGS. 7, 8A, and 8B, the virtual vehicle 600 may be displayed on one or more display units within the vehicle's cabin, such as the rear-view mirror, side mirrors, or in-dash display unit. As the vehicle 100 moves along the track, the virtual vehicle 600 may transition between these display units to provide real-time feedback to the driver about the vehicle's position and speed relative to the best line. For example, the virtual vehicle 600 may appear in the rear-view mirror when the vehicle 100 is approaching a straight section of the track, and then transition to the left or right side-view mirror when the vehicle 100 is entering a curve. This allows the driver to track the virtual vehicle's 600 movements and adjust their driving accordingly.

Additionally, the virtual vehicle 600 may be used to simultaneously correct the lateral position and speed of the vehicle 100. For example, in the examples of FIGS. 8A and 8B, if the vehicle 100 is not satisfying the speed condition and has deviated from the best line 800 or 802, the virtual vehicle 600 may appear to be approaching the vehicle 100 in the direction D1. That is, the distance between the virtual vehicle 600 and the vehicle 100 may appear to be less than a distance threshold. The approaching virtual vehicle 600 may serve as a visual cue to the driver to accelerate and make the necessary steering corrections to return the vehicle 100 to the best line 800 or 802.

Various aspects of the present disclosure may be implemented via various display-units of a vehicle, including, but not limited to side-view mirrors, in-dash displays, and/or a backup camera display on the vehicle's console and/or dashboard. These display surfaces can be utilized to provide real-time guidance and feedback to the driver by displaying a simulated vehicle. By using this approach, the driver can improve their driving skills and performance on the race track. Moreover, the use of a simulated vehicle displayed within a mirror or other interface can reduce the need for a human instructor during training sessions, making it a cost-effective and time-efficient solution. The use of a virtual vehicle displayed in various surfaces provides an enhanced and more comprehensive field of vision, allowing the driver to improve their situational awareness and decision-making skills while navigating the race track. Overall, this approach can benefit both novice and experienced drivers alike, providing a versatile and effective tool for improving their driving abilities.

FIG. 9 is a diagram illustrating an example process 900 performed in accordance with various aspects of the present disclosure. The process 900 may be performed by a vehicle, such as a vehicle 100 as described with reference to FIGS. 1A 1B, 3, 7, 8A, and 8B/The example process 900 is an example of training a driver via a virtual vehicle. As shown in the example of FIG. 9, the process 900 begins at block 902 by displaying a virtual vehicle on one or more display units integrated with a vehicle, the virtual vehicle being displayed as following the vehicle. At block 904, the process 900 monitors a location of the vehicle and a speed of the vehicle along the path. At block 906, the process 900 adjusts one or both of an angle of the virtual vehicle in relation to the vehicle or a distance between the virtual vehicle and the vehicle based on monitoring the location and the speed, such that the driver adjusts one or both of a lateral position of the vehicle on the path or the speed of the vehicle in accordance with one or both of the adjusted angle or the adjusted distance.

Based on the teachings, one skilled in the art should appreciate that the scope of the present disclosure is intended to cover any aspect of the present disclosure, whether implemented independently of or combined with any other aspect of the present disclosure. For example, an apparatus may be implemented or a method may be practiced using any number of the aspects set forth. In addition, the scope of the present disclosure is intended to cover such an apparatus or method practiced using other structure, functionality, or structure and functionality in addition to, or other than the various aspects of the present disclosure set forth. It should be understood that any aspect of the present disclosure may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the present disclosure. Although some benefits and advantages of the preferred aspects are mentioned, the scope of the present disclosure is not intended to be limited to particular benefits, uses or objectives. Rather, aspects of the present disclosure are intended to be broadly applicable to different technologies, system configurations, networks and protocols, some of which are illustrated by way of example in the figures and in the following description of the preferred aspects. The detailed description and drawings are merely illustrative of the present disclosure rather than limiting, the scope of the present disclosure being defined by the appended claims and equivalents thereof.

As used herein, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a processor specially configured to perform the functions discussed in the present disclosure. The processor may be a neural network processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. Alternatively, the processing system may comprise one or more neuromorphic processors for implementing the neuron models and models of neural systems described herein. The processor may be a microprocessor, controller, microcontroller, or state machine specially configured as described herein. A processor may also be implemented as a combination of computing devices, e.g., a combination of a DSP and a microprocessor, a plurality of microprocessors, one or more microprocessors in conjunction with a DSP core, or such other special configuration, as described herein.

The steps of a method or algorithm described in connection with the present disclosure may be embodied directly in hardware, in a software module executed by a processor, or in a combination of the two. A software module may reside in storage or machine readable medium, including random access memory (RAM), read only memory (ROM), flash memory, erasable programmable read-only memory (EPROM), electrically erasable programmable read-only memory (EEPROM), registers, a hard disk, a removable disk, a CD-ROM or other optical disk storage, magnetic disk storage or other magnetic storage devices, or any other medium that can be used to carry or store desired program code in the form of instructions or data structures and that can be accessed by a computer. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and processing, including the execution of software stored on the machine-readable media. Software shall be construed to mean instructions, data, or any combination thereof, whether referred to as software, firmware, middleware, microcode, hardware description language, or otherwise.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or specialized register files. Although the various components discussed may be described as having a specific location, such as a local component, they may also be configured in various ways, such as certain components being configured as part of a distributed computing system.

The machine-readable media may comprise a number of software modules. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a special purpose register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any storage medium that facilitates transfer of a computer program from one place to another.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means, such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A method for training a driver to navigate a path, comprising:
displaying a virtual vehicle on one or more display units integrated with a vehicle, the virtual vehicle being displayed as following the vehicle;
monitoring a location of the vehicle and a speed of the vehicle along the path; and
adjusting one or both of an angle of the virtual vehicle in relation to the vehicle or a distance between the virtual vehicle and the vehicle based on monitoring the location and the speed, such that the driver adjusts one or both of a lateral position of the vehicle on the path or the speed of the vehicle in accordance with one or both of the adjusted angle or the adjusted distance.

2. The method of claim 1, wherein the distance between the virtual vehicle and the vehicle is reduced based on the speed of vehicle failing to satisfy a speed condition associated with a particular section of the path.

3. The method of claim 2, further comprising adjusting one or both of a color or an intensity of the virtual vehicle to indicate the speed of vehicle fails to satisfy the speed condition.

4. The method of claim 1, wherein the one or more display units include one or more of a rear-view mirror, a left side-view mirror, a right side-view mirror, an in-dash display, or a console display.

5. The method of claim 1, further comprising determining an ideal route along the path, wherein:
the path is a race track; and
the ideal route is associated with a fastest lap time.

6. The method of claim 1, further comprising:
determining a first difference between a current location, of the vehicle, on the path and an ideal location associated with the ideal route in accordance with monitoring the location of the vehicle; and
determining a second difference between a current speed, of the vehicle, and an ideal speed associated with the current location of the vehicle relative to the ideal route in accordance with monitoring the location and the speed of the vehicle.

7. The method of claim 6, wherein:
the angle of the virtual vehicle is adjusted based on the first difference being greater than a distance threshold; and
the distance is adjusted based on the second difference being greater than a speed threshold.

8. An apparatus for training a driver to navigate a path, comprising:
a processor; and
a memory coupled with the processor and storing instructions operable, when executed by the processor, to cause the apparatus to:
display a virtual vehicle on one or more display units integrated with a vehicle, the virtual vehicle being displayed as following the vehicle;
monitor a location of the vehicle and a speed of the vehicle along the path; and
adjust one or both of an angle of the virtual vehicle in relation to the vehicle or a distance between the virtual vehicle and the vehicle based on monitoring the location and the speed, such that the driver adjusts one or both of a lateral position of the vehicle on the path or the speed of the vehicle in accordance with one or both of the adjusted angle or the adjusted distance.

9. The apparatus of claim 8, wherein the distance between the virtual vehicle and the vehicle is reduced based on the speed of vehicle failing to satisfy a speed condition associated with a particular section of the path.

10. The apparatus of claim 9, wherein execution of the instructions further cause the apparatus to adjust one or both of a color or an intensity of the virtual vehicle to indicate the speed of vehicle fails to satisfy the speed condition.

11. The apparatus of claim 8, wherein the one or more display units include one or more of a rear-view mirror, a left side-view mirror, a right side-view mirror, an in-dash display, or a console display.

12. The apparatus of claim 8, wherein execution of the instructions further cause the apparatus to determine an ideal route along the path, wherein:
the path is a race track; and
the ideal route is associated with a fastest lap time.

13. The apparatus of claim 8, wherein execution of the instructions further cause the apparatus to:
determine a first difference between a current location, of the vehicle, on the path and an ideal location associated with the ideal route in accordance with monitoring the location of the vehicle; and
determine a second difference between a current speed, of the vehicle, and an ideal speed associated with the current location of the vehicle relative to the ideal route in accordance with monitoring the location and the speed of the vehicle.

14. The apparatus of claim 13, wherein:
the angle of the virtual vehicle is adjusted based on the first difference being greater than a distance threshold; and
the distance is adjusted based on the second difference being greater than a speed threshold.

15. A non-transitory computer-readable medium having program code recorded thereon for training a driver to navigate a path, the program code executed by a processor and comprising:
program code to display a virtual vehicle on one or more display units integrated with a vehicle, the virtual vehicle being displayed as following the vehicle;
program code to monitor a location of the vehicle and a speed of the vehicle along the path; and
program code to adjust one or both of an angle of the virtual vehicle in relation to the vehicle or a distance between the virtual vehicle and the vehicle based on monitoring the location and the speed, such that the driver adjusts one or both of a lateral position of the vehicle on the path or the speed of the vehicle in accordance with one or both of the adjusted angle or the adjusted distance.

16. The non-transitory computer-readable medium of claim 15, wherein the distance between the virtual vehicle and the vehicle is reduced based on the speed of vehicle failing to satisfy a speed condition associated with a particular section of the path.

17. The non-transitory computer-readable medium of claim 15, wherein the one or more display units include one or more of a rear-view mirror, a left side-view mirror, a right side-view mirror, an in-dash display, or a console display.

18. The apparatus of claim 15, wherein the program code further comprises program code to determine an ideal route along the path, wherein:
the path is a race track; and
the ideal route is associated with a fastest lap time.

19. The apparatus of claim 15, wherein the program code further comprises:
program code to determine a first difference between a current location, of the vehicle, on the path and an ideal location associated with the ideal route in accordance with monitoring the location of the vehicle; and
program code to determine a second difference between a current speed, of the vehicle, and an ideal speed associated with the current location of the vehicle relative to the ideal route in accordance with monitoring the location and the speed of the vehicle.

20. The apparatus of claim 19, wherein:
the angle of the virtual vehicle is adjusted based on the first difference being greater than a distance threshold; and
the distance is adjusted based on the second difference being greater than a speed threshold.
